(19) United States
(12) Patent Application Publication
(10) Pub. No.: US 2012/0141139 A1
(43) Pub. Date: Jun. 7, 2012

(54) System and Method for Optical-Electrical-Optical Reach Extension in a Passive Optical Network

(76) Inventors: Umesh Bakhru, North Brunswick, NJ (US); Allan Ghaemi, Princeton, NJ (US); Paul Grabbe, Tinton Falls, NJ (US); Abhishek Kala, Voorhees, NJ (US); Sharief Megeed, Somerset, NJ (US); Janar Thoguluva, North Brunswick, NJ (US); Martin Varghese, Eatontown, NJ (US)

(21) Appl. No.: 13/196,432

(22) Filed: Aug. 2, 2011

Related U.S. Application Data
(60) Provisional application No. 61/374,428, filed on Aug. 17, 2010.

(51) Int. Cl. H04B 10/00

(52) U.S. Cl. 398/158

(57) ABSTRACT

A system and method are disclosed in which an optical network may include an optical-electrical converter module within an OEO (Optical Electrical Optical) reach extension system (OEO RE system), the OEO RE system having an OEO port and including a downstream frame regeneration block; and a downstream control data extraction block including a GPON operating parameter extraction module (GOPEM), wherein the GOPEM is operable to extract at least one OEO-port operating parameter from data frames arriving at the GOPEM module.

### CROSS-REFERENCE TO RELATED APPLICATIONS

This application claims the benefit of U.S. Provisional Patent Application Ser. No. 61/374,428, filed Aug. 17, 2010, [Attorney Docket No. 312-45], entitled “System and Method for Optical-Electrical-Optical Reach Extension in a Passive Optical Network”, the entire disclosure of which application is hereby incorporated by reference herein.

### BACKGROUND OF THE INVENTION

The ever-growing demand for high-speed broadband services has fueled interest in fiber-based access networks. Among the different architectures in which fiber-based access networks can be realized, the Passive Optical Network (PON) technology has become the architecture of choice for network operators due to the low cost, low maintenance, and high reliability of the passive network elements involved, and helps avoid the need for electrical power in order to operate.

Passive, point-to-point fiber-based access networks can be implemented, such as the fiber-based point to point Ethernet architecture. However, the PON architecture, because of cost and fiber management reasons, has been implemented primarily using a point to multipoint architecture, with a single fiber being extended from a telecom central office facility to a splitting point from which a plurality of shorter fibers are then extended to a plurality of respective subscribers.

The PON technology exists in multiple implementations, such as GPON (Gigabit Passive Optical Network) and EPON (Ethernet Passive Optical Network), which differ from one another as a result of factors such as: the transmission protocol; the bit rate; and/or the number of possible splits (the number of point to multi-point splits in the transmission line).

An existing PON architecture is illustrated in FIG. 1. The Optical Line Terminal (OLT) 202 is the equipment that resides at a telecom central office facility and connects to packet network 201 by way of service-network equipment such as the Internet Gateway, Internet Protocol Television (IPTV) server, and the Voice Over Internet Protocol (VOIP) Gateway. The Optical Network Unit (ONU) 205 is equipment that resides at the subscriber premises and to which subscriber service terminals such as telephone(s) and/or personal computer(s) can be connected. A single feeder (also referred to as a “trunk fiber”) extends from the OLT 202 to the passive optical splitter 204, to which fiber segments, known as the distribution or drop fibers, are then extended to ONUs 205, 206, etc. It is noted that the distribution fibers are of varying length to accommodate the different distances of the various subscriber premises (205, 206 etc.) to the optical splitter 204.

To meet the increasing demand for broadband access, network operators would have to increase the number of users and coverage area by increasing the fiber distance and/or split ratios. As they attempt to do this, network operators face losses in the optical signal due to physical limits of the optical fiber. Accordingly, there is a need in the art for improved systems and methods for data communication in passive optical networks.

### SUMMARY OF THE INVENTION

According to one aspect, the present invention is direct to an optical network that may include an optical-electrical converter module within an OEO (Optical Electrical Optical) reach extension system (OEO RE system), the OEO RE system having an OEO port and including a downstream frame regeneration block; and a downstream control data extraction block including a GPON operating parameter extraction module (GOPEM), wherein the GOPEM is operable to extract at least one OEO-port operating parameter from data frames arriving at the GOPEM module.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram of a GPON network;

FIG. 2 is a block diagram of a frame structure of a downstream bound data frame in an optical network in accordance with an embodiment of the present invention;

FIG. 3 is a block diagram of a frame structure of an upstream bound data frame in an optical network in accordance with an embodiment of the present invention;

FIG. 4 is a block diagram of a GPON network with a reach extender system in accordance with an embodiment of the present invention;

FIG. 5 is a block diagram of a GPON network having a split in the electrical component of a reach extension system in accordance with an embodiment of the present invention;

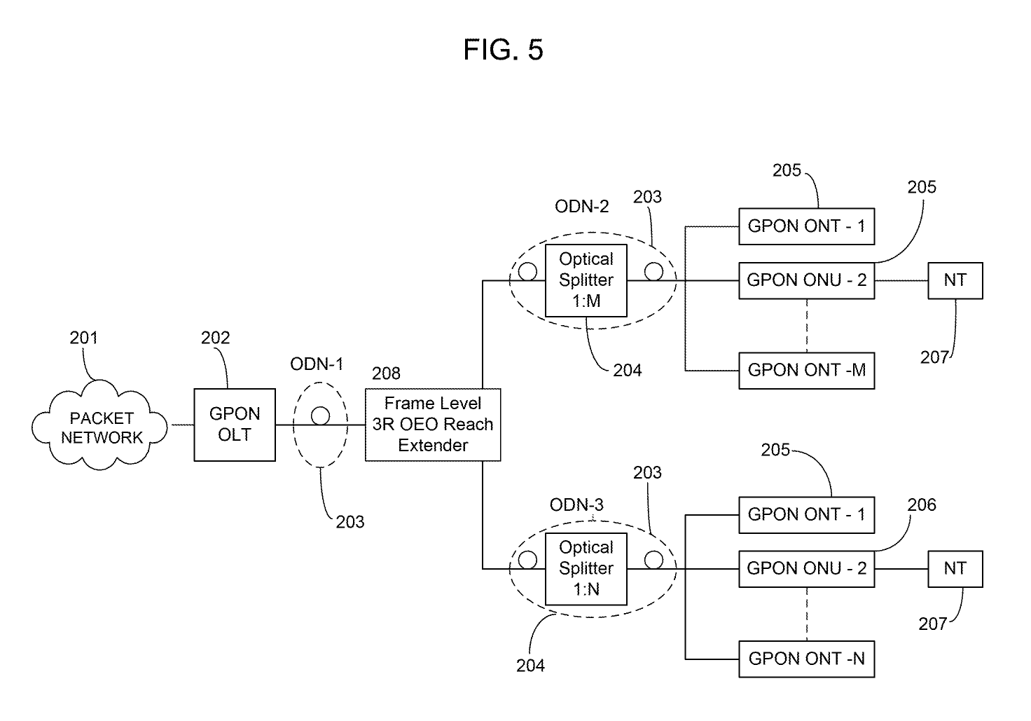

FIG. 6 is a block diagram of a reach extension system in GPON network having path protection in accordance with an embodiment of the present invention;

FIG. 7 is a block diagram of a high-level architecture of a GPON reach extension system in accordance with an embodiment of the present invention;

FIG. 8 is a block diagram of detailed architecture of a GPON reach extension system in accordance with an embodiment of the present invention;

FIG. 9 is a block diagram showing the physical locations of optical network units (ONUs) in a system in accordance with an embodiment of the present invention;

FIG. 10 is a timing diagram showing delay measurements implemented during a ranging process in accordance with an embodiment of the present invention;

FIG. 11 is a timing diagram showing measured delay period during a normal operating mode of a system in accordance with an embodiment of the present invention;

FIG. 12 timing diagram showing bursts during normal operation with respect to synchronization delay in accordance with an embodiment of the present invention; and

FIG. 13 is a block diagram of a computer system useable in conjunction with one or more embodiments of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

| Acronym | Description |
|---|---|
| 3R | Reception, Recovery and Re-Timing |
| BCDR | Burst-Mode Clock and Data Recovery |
| CDR | Clock and Data Recovery |
| DS | Downstream |
| E/O | Electrical-Optical Converter |
| FEC | Forward Error Correction |
| GPON | Gigabit Passive Optical Network |
| NT | Network Termination |
| O/E | Optical-Electrical Converter |
| OA | Optical Amplification |
| OAM | Operations, Administrations and Maintenance |
| ODN | Optical Distribution Network |
| OEO | Optical-Electrical-Optical Converter |
| OLT | Optical Line Termination |
| OMCI | Optical Network Unit Management and Control |
| | Interface |
| ONT | Optical Network Termination |
| ONU | Optical Network Unit |
| OTL | Optical Trunk Line |
| OTN | Optical Transport Network |
| PCBd | Physical Control Block Downstream |
| PLOAM | Physical Layer OAM Operations, Administrations |
| | And Maintenance |
| PLOAMd | Physical Layer OAM Operations, Administrations |
| | And Maintenance downstream |
| PON | Passive Optical Network |
| PSYNC | Physical Synchronization |
| RE | Reach Extender |
| RSSI | Received Signal Strength Indication |
| US | Upstream |

A method and apparatus for amplifying the GPON optical signal using Optical-to-Electrical-to-Optical (OEO) style Reception, Recovery and Re-Timing (3R) Amplification. To achieve accurate and transparent behavior the signal is regenerated at the Frame Level. The core of the method involves deframing the downstream signal to automatically extract the GPON operating parameters and upstream burst control data, and using it to de-frame, decipher and process the upstream signal. The precise determination of the upstream burst boundaries allows for precise per burst resets to the upstream O/E converter module and upstream restoration of preamble and delimiter bits. Using a Forward Error Correction (FEC) module, the Frame Level OEO re-generator can autonomously determine the dynamic FEC state and correct the errors before relaying to the OLT in upstream direction and ONUs in the downstream direction.

Embodiments herein are directed to a system that may include one or more of the following features.

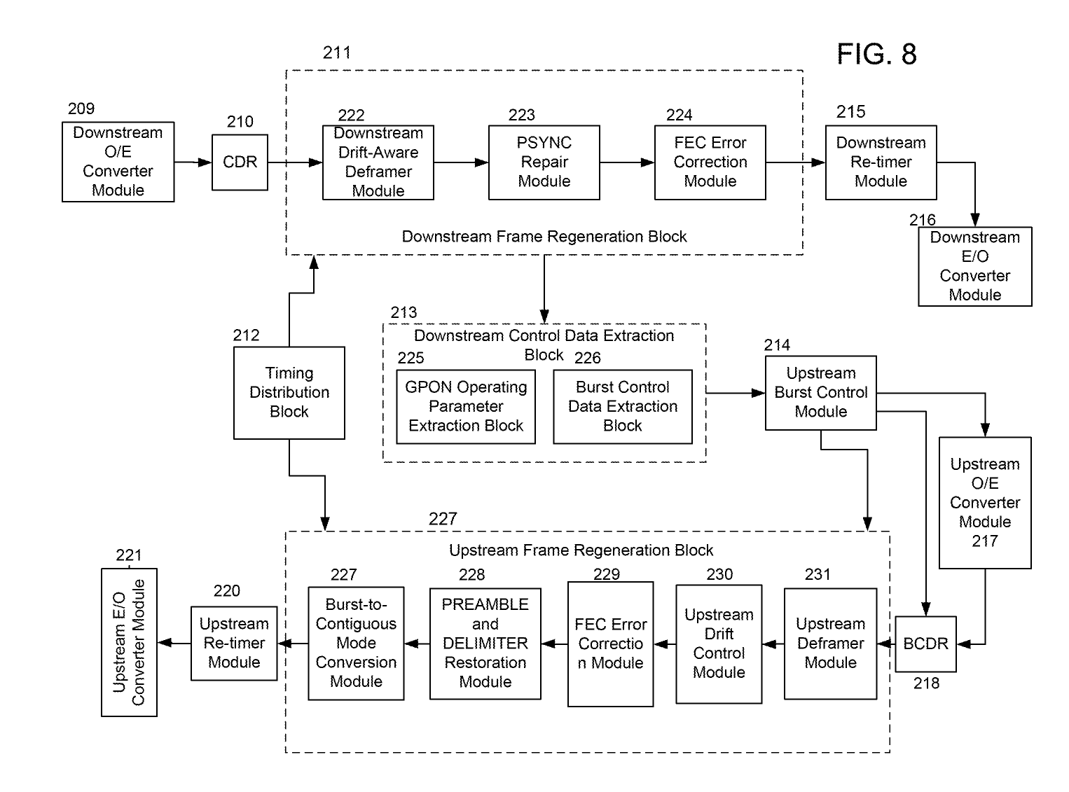

An embodiment may include a downstream clock and data recovery block [210] which extracts the clock and network timing apart from the essential data recovery. A timing distribution block uses the extracted network timing from the downstream signal to distribute clock and timing to other processing blocks to implement synchronous data transfer operations. (FIG. 8)

An embodiment may include a downstream Frame Regeneration Block [211] that may include a Drift-aware De-framer module which has an elastic buffer to compensate the drift introduced in the OLT to OEO fiber length.

An embodiment may include a GPON operating parameter extraction module [225] that autonomously extracts the GPON port's operating parameters such as an upstream preamble pattern and size, upstream delimiter pattern and size, and/or appropriate equalization delay to be used in the upstream to downstream synchronization.

An embodiment may include a Burst Control Data Extraction module [226] that automatically extracts the upstream burst control data to be used for precise determination of the upstream burst boundaries.

An embodiment may include a downstream Physical Synchronization (PSYNC) Pattern Repair Module [223] that has the ability to correct the number of impaired bits in the received PSYNC pattern. This will improve the user ONU's ability to correctly de-frame the received data frames.

An embodiment may include a downstream FEC Error Correction Module 224 that automatically determines the FEC state and applies FEC correction as required.

An embodiment may include a downstream Re-timer module 215 that precisely re-times the transmit data to the ONUs with the clock recovered from the downstream data stream for synchronous operation.

An embodiment may include an upstream Frame Regeneration Block 219 consisting of an upstream de-framer module that uses the extracted burst control data from the downstream data stream to precisely determine the upstream burst boundaries. Precise frame delineation is achieved by searching delimiter pattern only at the expected time. Delimiter detection is blocked at other times to prevent false detection of a possible occurrence of the delimiter pattern in the burst payload.

An embodiment may include an Upstream Burst Control Module 214 that determines the time intervals at which to reset the O/E converters which may use burst mode resets for efficient Optical-to-Electrical conversion.

An embodiment may include Upstream Burst Control Module 214 that also generates the dynamic noise squelch control to Burst-mode CDR block based on the knowledge of expected burst boundaries. This improves the Burst-mode CDR's capability to fast lock to the input data stream resulting in measurable packet error rate performance.

An embodiment may include an upstream Drift Control module 230 to compensate for the drift introduced in the O/E conversion and CDR processes. This module employs a self-adjustable elastic buffer to compensate for the received drift.

An embodiment may include a Preamble and Delimiter Restoration module 228 that has the ability to precisely restore the preamble and delimiter bits impaired during the O/E conversion. The preamble and delimiter pattern and size used by the GPON port is determined automatically in the GPON Parameter Extraction module.

An embodiment may include an upstream FEC Error Correction module 229 that has the ability to correctly determine the FEC status burst by burst with the help of the Burst-Control Data Extraction module, and that applies the FEC correction as determined.

An embodiment may include an upstream Re-timer module 220 that precisely re-times the upstream transmit data to the OLT with the clock recovered from the downstream data stream for synchronous operation.

An embodiment may include a burst-to-continuous mode conversion module that determines the upstream transmit burst boundaries and precisely fills the gap between two adjacent bursts with a known pattern in the same time domain to convert the upstream burst data to continuous-mode data for further transmission to the OLT. This allows the use of continuous-mode optical receiver and CDR at the OLT reducing the cost and improving the bit error rate performance. Converting to continuous mode transmission also allows the use of generic data transport technologies such as OTN to transport a GPON signal.

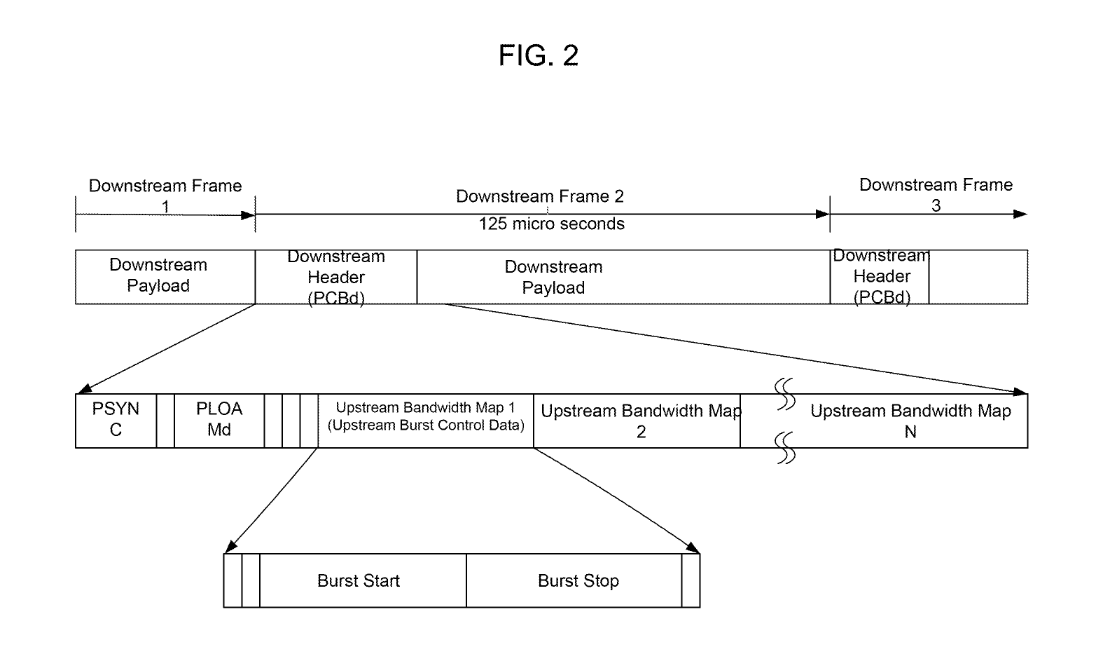

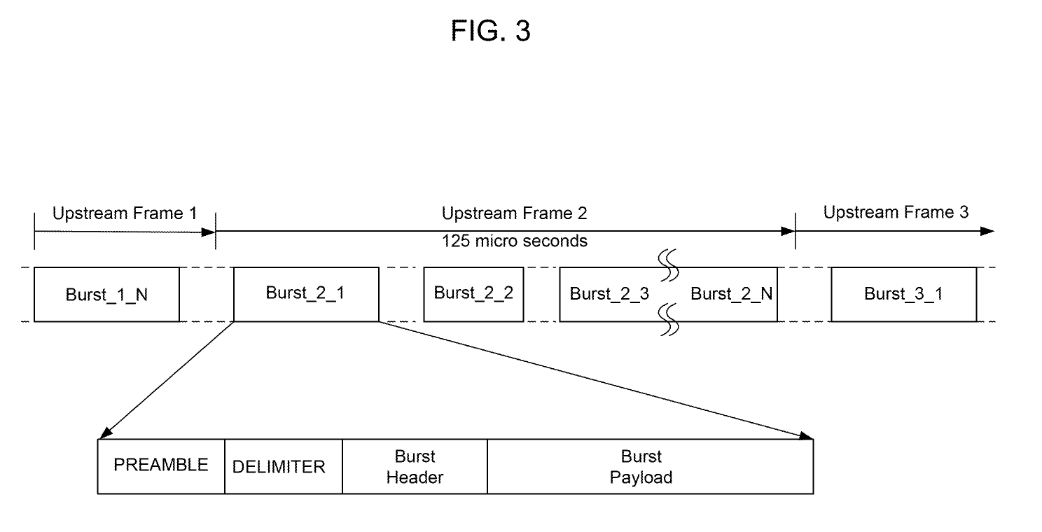

Herein, the direction from OLT 202 to ONU 206 is referred to as the downstream direction; and the direction from ONU 206 to OLT 202 is the upstream direction. The frame structure for the downstream direction is shown in FIG. 2; and the frame structure for the upstream direction is shown in FIG. 3. Due to the point-to-multipoint nature of the PON network, the downstream traffic (from the OLT to the ONUs), is inherently broadcast to all the ONUs. The Destination-ONU field in the downstream messages is used by the ONUs to filter the messages and to only process messages that are addressed to that destination ONU.

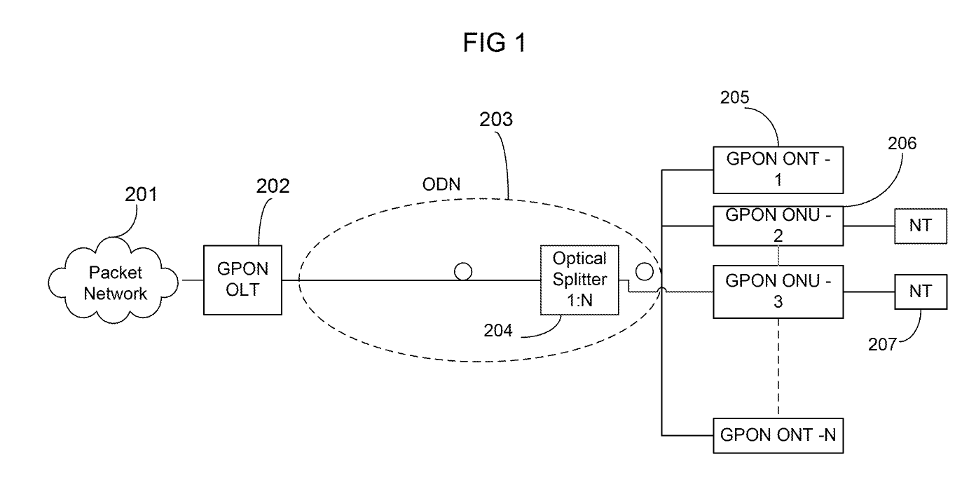

A note regarding notation: the term ONU refers to Optical Network Unit, and ONT to optical network termination. Reference is made herein to ONU 206, though this unit is called out as ONT-1 205 in FIG. 1, and other figures. In the case of ONT-1 205 the ONU and network termination (NT 207) are treated as being incorporated into a single functional block. For other ONUs shown in FIG. 1, the ONU portion and NT portions for each subscriber location are called out separately. Accordingly, ONU 206 as referred to herein is considered to be included within ONT 205 as shown in the Figures.

In the upstream direction (from the ONU to the OLT), due to the point to multipoint nature of the PON, a Time Division Multiple Access (TDMA) scheme is employed wherein the OLT, being the master of the shared PON medium, schedules, in a tightly controlled manner, transmission opportunities for the optical transmitter at the ONUs so that the transmissions from different ONUs do not interfere with one another. Thus, the ONU transmitters preferably operate in a burst-mode in which the transmitter transmits light only when instructed to do, and over a precisely defined time period, to thereby avoid interfering with light transmissions from other ONUs. The instructions defining when to begin light transmissions by an ONU, and the duration over which an ONU may transmit light are preferably provided by the OLT in communication with that ONU.

This control information of when and how long a given ONU's transmitter can transmit, referred to as Bandwidth Map or BWmap, can be provided to the ONU by the OLT as part of the PON protocol overhead in the downstream frame, as illustrated in FIG. 2. From the point of view of the OLT 202, besides the fact that the transmission opportunities offered to the ONUs, referred to as upstream bursts, vary in the precise time and duration, due to the varying distances of the ONUs from the OLT, the relative intensity of the optical signal received from the upstream bursts from different ONUs can vary widely.

In order to determine and assign the time and duration of the upstream transmission opportunities for the ONUs, the OLT makes use of a hypothetical upstream reference frame relative to whose start it assigns the start and end bit-locations for the different bursts. As stated earlier, the OLT conveys the start-bit and end bit-locations to the ONUs as part of the bandwidth control (Bw-map) information in the downstream protocol overhead fields.

Also, in the upstream direction, a training pattern called the “preamble” is used primarily for clock recovery. Use of the correct number of preamble bits is operable to ensure that the Burst-mode clock recovery logic correctly recovers the clock to sample the data bits.

Another operational task in a PON network is to determine the relative positions of the ONUs with respect to the OLT. The OLT uses this information to synchronize transmissions from each ONU in the time domain. This synchronization enables data transmission to occur in the upstream direction (i.e. from the ONUs to the OLT) in a time-division-multiplexed mode, while avoiding interference of the various data transmissions with one another.

The method of determining the ONUs' round-trip delay from the OLT, and assigning equalization delays to the respective ONUs' upstream transmissions is referred to as “ranging,” which is addressed in greater detail below.

### PON Reach Extension

The distance between the OLT and the farthest ONU, referred as the maximum reach of the PON, is limited by factors including: the maximum power level of the transmitter, the minimum tolerated receive power level (sensitivity) of the receiver, and the maximum optical path loss due to the optical fiber's inherent attenuation, and the split ratio. For example, the maximum reach of the GPON technology with the current state-of-the-art transceivers is roughly 20 km for a 32-split PON.

It is desirable among network operators to support a longer reach than what is possible with the current start of the art transceivers, in order to service hard-to-reach subscribers (e.g., in rural areas) and to increase the number of subscribers that can be served on a single PON. PON reach extension is a technique that helps overcome the maximum reach limitation of conventional PONs by introducing a reach extension network element at an appropriate location between the OLT and the ONT, typically co-located or close to the splitter.

There are different types of PON Reach Extender implementations. The “reach extender” described herein refers to an Optical-Electrical-Optical (OEO) type Reach Extender, in which an optical signal is converted into the electrical domain for regeneration and amplification by reception, recovery, and retiming (The 3R method). More precisely the systems and methods discussed herein concerns Frame-Level 3R OEO Reach Extenders.

### PON Reach Extension—Introduction

The following are characteristics of the conventional 3R OEO REs that do not employ frame-level regeneration.

Drift compensation: In the upstream direction, the burst mode clock and data recovery process introduces an inherent uncertainty, which manifests as additional drift at the OLT. This drift, when combined with the fiber-induced additional drifts caused by changes in the physical environment, such as temperature, can become significant enough for the OLT to perform re-ranging on that ONU. Embodiments disclosed herein, as will be described later, have the ability to compensate for the internally introduced drift.

Error-free preamble restoration: In the burst reception process in the upstream direction, due to the O/E conversion and upstream receiver processing, some of the preamble bits are lost and need to be restored before the upstream frame is transmitted to the OLT. Some 3R OEO RE (Reach Extension) implementations restore the lost preamble bits by searching for the delimiter pattern in the upstream data, and inserting the lost number of preamble bits right before the point at which the detected delimiter starts. However, this method is prone to incorrectly interpreting ordinary payload data as delimiter bits and to improperly inserting preamble bits where the preamble bits don't belong.

Besides, since the OLT controls the pattern and size of the delimiter. The network operator will need to configure the delimiter pattern and size anytime it needs to change. More specifically, the OLT sends a broadcast PLOAM message (of the type “Upstream_Overhead message”) to all of the ONUs in the system. This message contains information about operating parameters of the GPON network, such as, but not limited to preamble size, preamble pattern, and delimiter pattern.

An alternative process for restoring the lost preamble bits is for the OLT, on learning of the presence of a Reach Extension in the PON, to read (via a management channel) the additional preamble requirement of the RE, and the OLT transmits a broadcast PLOAM message (of the type “Upstream_Overhead message”) to all of the ONUs in the system with updated information about operating parameters such as, but not limited to preamble size, preamble pattern, and delimiter pattern. Although this method relieves the 3R OEO RE from having to restore the lost preamble bits, this method requires that the OLT support the above mentioned capability of discovering the presence of RE and re-transmitting the broadcast PLOAM message, thereby making the reach extension non-transparent. Also, this method reduces the available upstream bandwidth on the PON (that could otherwise be used for subscribers), since the size of the protocol overhead is higher due to the increased preamble size.

### Error-Free Burst-Mode Clock and Data Recovery:

In the conventional 3R OEO REs, the BCDR device employed in the upstream direction recovers the clock signal, using the preamble pattern without having advance knowledge of the burst boundaries. This method, however, leads to false recovery of the clock and phase locking if the preamble pattern occurs in the data payload, which in turn leads to user data corruption or loss. This shortcoming is overcome in the present invention, as will be described later, by making use of the knowledge of the burst (preamble) arrival time to precisely know when to enable clock recovery and phase locking to the received data stream.

Taking advantage of the O/E converter's receiver-threshold reset capability: In order to improve the signal-to-noise ratio in the upstream regeneration process, the state-of-the-art upstream O/E converters used in PON systems support the capability to reset the receiver threshold (the threshold that it uses to differentiate between an optical ‘1’ vs. optical ‘0’ on a burst-by-burst basis, such that the threshold can be set to a value that is optimal for a particular burst. However, conventional 3R OEO RE's that employ O/E converters with such a capability will not be able to take advantage of it, since they lack knowledge of the precise burst arrival times. Embodiments disclosed herein, as are described below, take advantage of the receiver-threshold reset capability to improve the upstream SNR performance.

### Preferred Embodiments

Traditional 3R repeaters (or amplifiers) do not repair frame level impairment precisely and accurately. In a GPON style burst-mode transmission environment repeaters or amplifiers will be inefficient if only pure 3R amplification is employed. Inefficiency results from the fact that the O/E conversion results in impairment of some important burst/frame header bits such as preamble, delimiter etc. Herein, we provide a system and method for accurately implementing a Frame level 3R regenerator. Frame level regeneration preferably provides the ability to precisely repair the impaired header error bits. The payload errors can also be fixed if a protocol-specific error correction method is used.

One aspect of burst-mode transmission in a GPON network is the timing of the upstream bursts. For an OEO style GPON amplifier to correctly receive and recover the burst data, the GPON amplifier preferably has knowledge of the burst time interval and resulting data transmission scheduling. Searching for and matching the delimiter pattern at the expected burst intervals eliminates the possibility of detecting a delimiter pattern during the payload portion of the burst, thereby avoiding possible false frame detection. Knowledge of the timing of the start of a of burst data transmission preferably enables restoration of the impaired preamble and delimiter bits before relaying the burst data to the OLT.

Herein, the expression “Frame Level 3R OEO Reach Extender” refers to the ability to Receive, Recover, Retime frame-level data. Below, the theory of operation of this Frame Level 3R OEO is described with reference to the Figures.

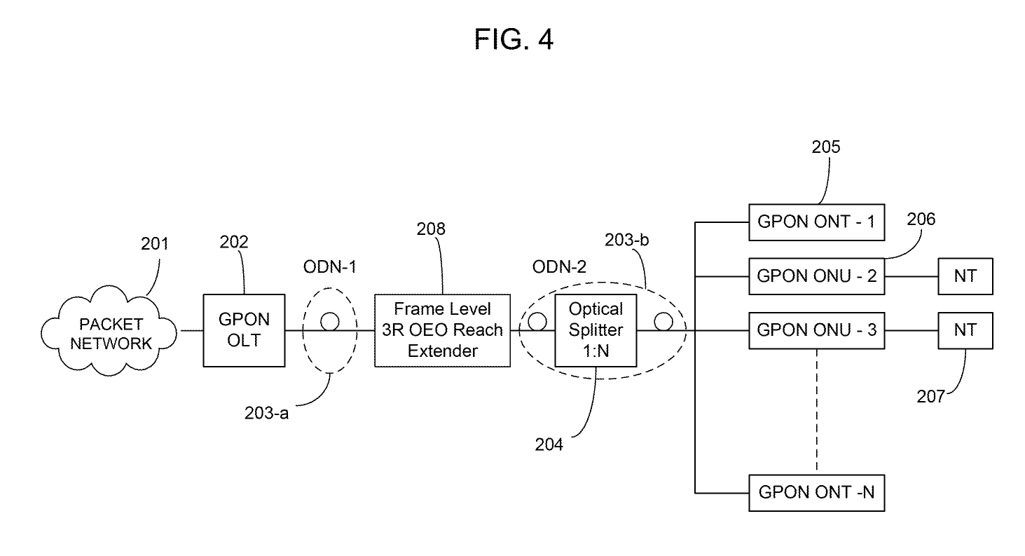

FIG. 4 is a network level overview of the how an OEO Reach Extender 208 is used in a PON network for various applications. The OEO in this claim could be used to extend the reach of the fiber beyond the standard 20 KM (Kilometer) range, or to increase the number of splits in the ODN (to increase the number of ONUs served), or for mere optical isolation.

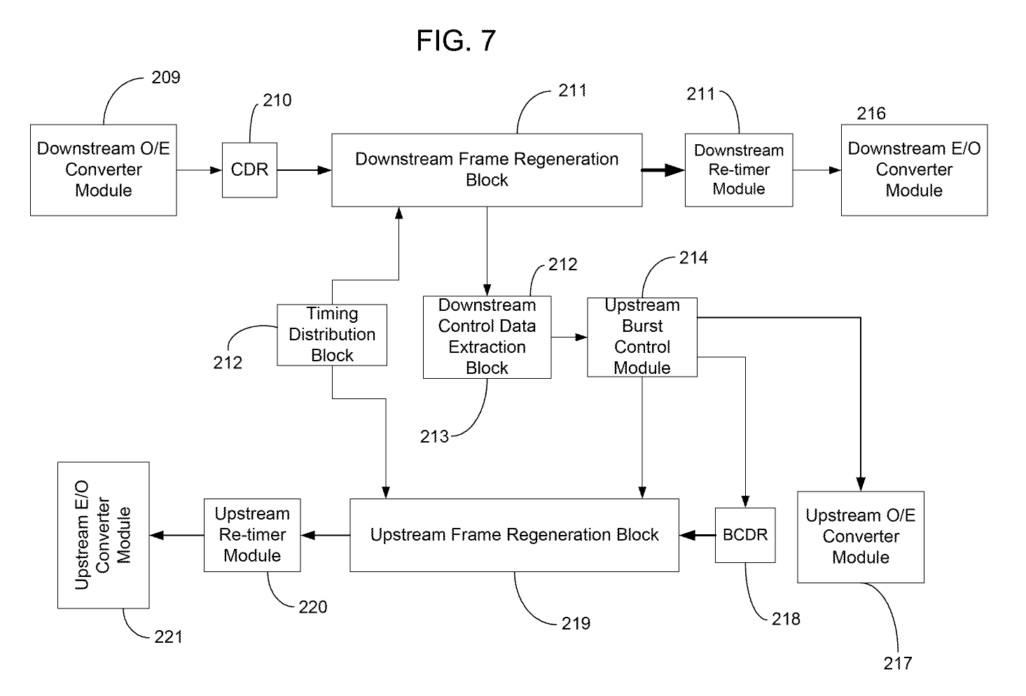

FIG. 7 is block diagram of a system for Frame-Level 3R Reach Extension in accordance with an embodiment of the present invention. The system of FIG. 7 may include converter module 209, CDR 210, regeneration block 211, re-timer module 215, converter module 216, timing distribution block 212, control data extraction block 213, upstream burst control module 214, upstream E/O converter module 221, upstream converter module 220, upstream from regeneration block 219, BCDR 218, and upstream O/E converter module 217.

On the downstream receive side, the system includes an O/E convertor 209 and CDR 210. Convertor 209 and CDR 210 receive and recover the data bits in the electrical domain. Also, the network timing information is derived by the CDR. Once the bit stream is recovered, it is sent to a Frame-Level Regeneration Block 211. The Downstream Control Data Extraction block 213 extracts the desired operating parameters and burst-control information from the deframed downstream signal. Extraction of the data, as described, arises from accurate de-framing of the downstream signal. The downstream Frame-Level Regeneration Block 211 also employs a PSYNC (the frame delineation pattern) Repair block 223 and a FEC Error Correction block 224 (FIG. 8). The FEC Error Correction module automatically determines the status of FEC and apply FEC correction if needed. The final framed and corrected data is send to the Downstream Re-timer module 215 for transmission through the E/O convertor 216.

FIG. 8 is a detailed block diagram of the Frame Level 3R OEO Reach Extender. The abbreviated expression “OEO” is used herein to refer to the “Frame Level 3R OEO Reach Extender” system shown in FIG. 8.

Referring to FIG. 8, on the upstream receiver side, the O/E convertor 217 combined with the Burst-mode CDR device 218 recover the data streams. The Frame Regeneration Block 219 deframes the recovered data streams using the expected burst interval information sent by the Burst Control Module 214. The system uses Upstream Deframer module 231 to search for a delimiter at the appropriate start burst time interval, a Drift Control module 230 to compensate the drift introduced in the O/E conversion, an FEC Error Correction module 229 for frame data error correction, a Preamble and Delimiter Restoration module 228 to restore the preamble and delimiter, and a Burst-to-Continuous Mode Conversion module 227 for converting a bursty traffic to a continuous mode traffic.

On the Downstream side the Drift-Aware Deframer Module's 222 main purpose is to deframe the downstream signal. To deframe the signal, the synchronization pattern PSYNC is determined in accordance with an applicable telecommunications standard, such as ITU-T G984.3. Once the start of a frame is identified, the data stream is descrambled and forwarded to the PSYNC-Repair Module 223. The data stream is also sent the Downstream Control Data Extraction Block 213 for extraction of information. The Downstream Drift-Aware Deframer Module 222 also monitors incoming drift. Drift may be found to exist when the PSYNC signal arrives early or late in relation to the initial PSYNC location. The drift is measured in number of bits.

The PSYNC-Repair Module 223 determines any errors in the PSYNC value (which may be “0xB6AB31E0”) and preferably makes an appropriate correction. The module also monitors number of PSYNC errors found. Once corrections are made, the data stream is sent to the FEC Error Correction Module.

The FEC Error Correction Module 224 determines whether Forward Error Correction (FEC) is enabled. If enabled the module determines the number of FEC errors found and the number of FEC errors that are correctable. Once the FEC errors are corrected, the data stream is sent to the Downstream Re-timer Module 215.

The Downstream Re-timer 215 Module re-clocks the data with the downstream recovered clock and sends it for transmission through the E/O convertor 216 for downstream transmission.

The GPON-Parameter-Extraction module 225 automatically extracts the GPON port's operating parameters including upstream preamble pattern and size, upstream delimiter pattern and the OED's equalization delay to be used in downstream to upstream synchronization. This makes the OEO self-reliant and not dependent on software support for configuration.

The Burst-Control-Data Extraction module 226 dynamically decodes the DS BW Map from the downstream frame header and extracts burst-control information that will be used by the US-Frame Regeneration Block 219 to detect bursts from the ONUs including but not limited to:

Expected start and end times of the Bursts; FEC status; ONU id; Ploam request status; and DBRu request status.

Details of the US Frame Regeneration Block 219 are shown in FIG. 8.

An Upstream Burst Control Module 214 determines the time intervals to reset the O/E converters which require burst mode resets for efficient Optical-to-Electrical conversion.

The Upstream Burst Control Module 214 also generates the dynamic noise squelch control to Burst-mode CDR block based on the knowledge of expected burst boundaries. This improves the Burst-mode CDR's capability to fast lock to the input data stream resulting in measurable packet error rate performance. The Upstream Deframer module 231 searches for the delimiter at the expected start burst time interval to determine the actual start of the burst in the received data. Delimiter detection is blocked at other times to prevent false detection of a possible occurrence of the delimiter pattern during the burst payload reception. The de-framed data is send through the Drift-Control module 230.

The Drift-Control module 230 compensates for the drift introduced in the O/E conversion. The drift control module 230 can also correct for any drift introduced in the ODN fiber if needed. The drift-compensated bursts are send to the FEC Error Correction module 229.

The FEC Error Correction module 229 determines the FEC status burst-by-burst using the information sent by downstream Burst-Control-Data Extraction module 226. If the FEC is enabled, the module determines if FEC errors exist and the number of correctable FEC errors. The FEC corrected data is sent to the Preamble and Delimiter Restoration module 228.

The Preamble and Delimiter Restoration module restores the preamble and delimiter based on the GPON port operating parameters that were extracted in the downstream side from the upstream Overhead PLOAM (Physical Layer Operations And Maintenance) message. The data bursts including the restored Preamble and Delimiter are sent to the Burst-to-Continuous Mode Conversion module 227.

The Burst-to-Continuous Mode Conversion module 227 converts the bursty upstream signal into a conventional continuously clocked signal. This allows the use of continuous mode optical receiver and CDR at the OLT reducing cost and chances of errors in the receive and recovery process. The continuous mode data is sent to the Re-timer module 220.

The Re-timer module 220 re-clocks the data with the downstream recovered clock and sends the data to E/O Conversion module 221 for upstream transmission to the OLT.

### Delay Measurement by Frame Level 3R OEO Reach Extender

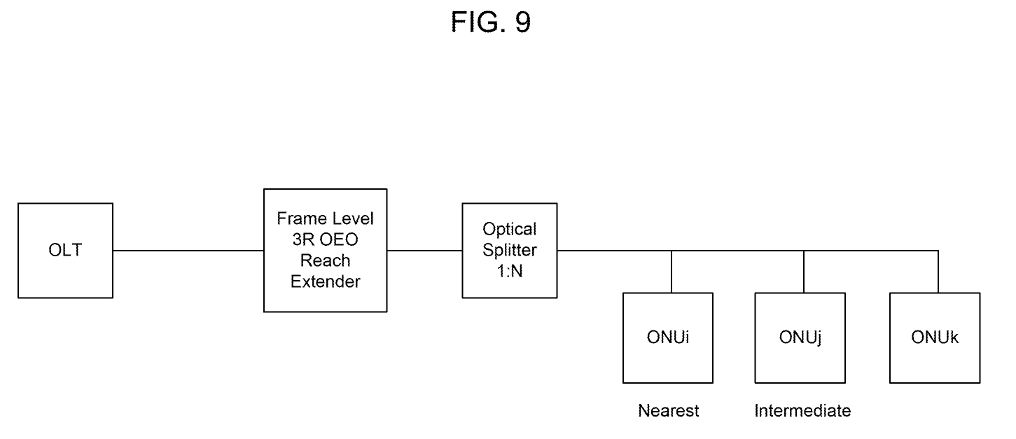

FIG. 9 shows the physical presence of various ONUs in the system. ONUi is the nearest ONU from the OLT and ONUk is at the maximum GPON reach distance.

The OLT performs the ranging operation on each ONU to precisely determine the distance each ONU from the OLT. The distance information is preferably employed to avoid data communication interference while conducting data transmission in the upstream direction (toward the OLT) within the optical network.

An embodiment of the Frame Level 3R OEO Reach Extender (also referred to as the “reach extender”) also performs delay measurement techniques to precisely determine the location of the Reach Extender itself, within the optical network shown in FIG. 9, with respect to the plurality of respective ONUs.

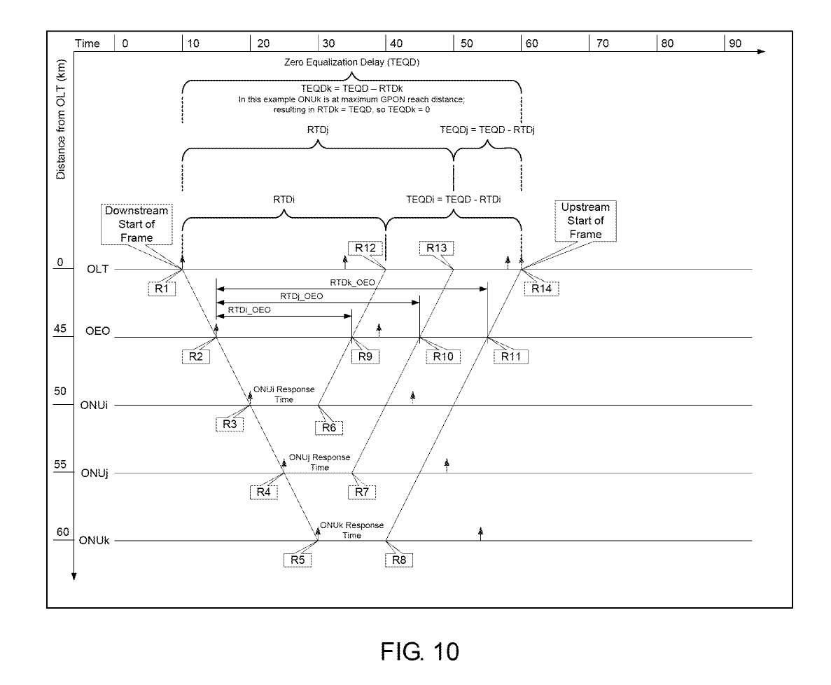

FIG. 10 shows the timing relationship of various events on the GPON link during a ranging operation and an embodiment of the delay measurement technique employed herein.

### Below is the Description of Various Time Indexes in the Figure

R1: The start of downstream frame with respect to the OLT and the transmission of the first bit by OLT in the downstream direction.

R2: After some time (R2−R1 time), due to propagation delay, this bit is received by the Frame-Level 3R Reach Extender (denoted “OEO” in FIG. 10), marking the start of downstream frame in OEO.

R3: The time at which ONUi (the ONU closest to the OLT) sees the first bit in the downstream direction.

R4: The time at which ONUj sees (receives) the first bit in the downstream direction.

R5: The time at which ONUk (the ONU farthest from the OLT) receives the first bit in the downstream direction.

### Ranging Process

In an embodiment, the OLT sends a Range Request message in the downstream direction at time R1. The range request message is then received by Frame Level 3R OEO Reach Extender (OEO) at time R2. The message is received by ONUi at time R3. ONUj and ONUk receive this range request message at times R4 and R5, respectively.

The ONUs are preferably configured and controlled so as to transmit a Range Response message immediately upon receiving the range request message from the OLT. In fact, each ONU incurs a delay due to an internal processing time (a delay due to processing at the ONU rather than the delay due to signal propagation time between the ONU and the OLT) before actually transmitting its own range response message. This will lead ONUs that are located at differing distances from the OLT to each have distinctive response time delays. More specifically, the delay times experienced by the OLT in between (a) transmitting the range request message and (b) receiving ONU-specific range response messages will be different for the respective ONUs, and are a function of the distances between the respective ONUs and the OLT.

Referring to FIG. 10, ONUi responds to the range request message with a range response message at time R6. The range response from ONUi is seen by the Reach Extender at time R9 and is received by the OLT at time R12.

Since the Reach Extender conducts frame level re-generation, it has knowledge of the time at which a range request for a particular ONU leaves in the downstream direction and the time at which the corresponding range response is received while traveling in the upstream direction. Based on this information, the OEO Reach Extender is able to readily determine the round trip request-response signal propagation delay of each ONU as experienced by the OEO range extender.

The total amount of time it takes the OEO range extender to receive a response back from ONUi may be expressed as R9−R2, which is defined as the Round Trip Delay of ONUi as seen by the OEO Range extender. The round trip delay for ONUi as experienced at the OEO range extender may be expressed as: RTDi_OEO.

Corresponding delay measurements can thus be made for other ONUs in the system, as shown below:

RTDi_{—}OEO=R9−R2;

RTDj_{—}OEO=R10−R2;

RTDk_{—}OEO=R11−R2.

The total amount of time it takes the OLT to receive a response back from ONUi=(R12−R1) which is defined as Round Trip Delay of ONUi back to the OLT, and this delay may be represented by the expression RTDi, (and may also be represented by the expression: RTDi_OLT). The pertinent delay is the delay between the transmission of the range request message from the OLT, and the receipt of the range response message at the OLT. As with the delay period experienced by the Ranger Extender, the delay period will generally be different for each ONU.

Corresponding delay periods may be determined for the other ONUs:

RTDi=R12−R1;

RTDj=R13−R1;

RTDk=R14−R1.

Based on the above measurements and calculations, the OLT is able to associate an Equalization Delay value for each ONU. Equalization Delay is the value by which the respective ONUs delay their data transmission operations in the upstream direction toward the OLT. In the embodiment shown in FIGS. 9-10, each ONU will have its own equalization delay, and the magnitudes of the respective delays will generally all be different from one another. The closer an ONU is to the OLT, the higher the equalization delay will be. Conversely, the farther an ONU is from the OLT, the lower the value of its equalization delay will be.

By properly establishing the delay values for the respective ONUs, the OLT ensures that data communication bursts arriving from different ONUs arrive at the OLT in an orderly, properly synchronized manner. Moreover, use of the correct delay values for the respective ONUs prevents (a) the data transmissions from the respective ONUs from interfering with one another and (b) also prevents data corruption from occurring due to data transmission interference.

If there is an ONU present at zero distance, its Equalization Delay will be maximum, which is represented by “Zero Equalization Delay” value (TEQD).

For ONU at maximum GPON reach distance, its Equalization Delay will be zero.

Equalization delay for individual ONUs is computed as follows:

TEQDi=TEQD−RTDi

Similarly for other ONUs

TEQDj=TEQD−RTDj

TEQDk=TEQD−RTDk

These delay values of TEQDi, TEQDj, TEQDk are programmed in the respective ONUs ONUi, ONUj, and ONUk through downstream transmission of the PLOAM (Physical Layer Operations And Maintenance) message.

Since the Frame Level 3R OEO Reach Extender operates at frame level re-generation, it has knowledge of the individual equalization delays of the various ONUs in the system.

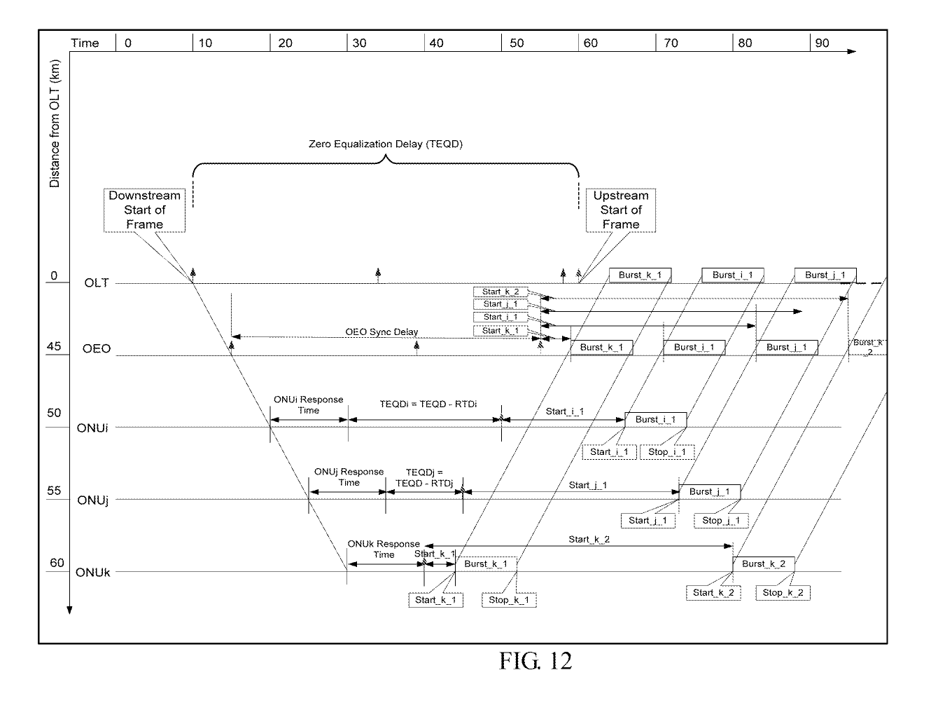

Note—FIGS. 9, 10, 11, and 12 are for illustrative purposes only. The time and distance values are represented arbitrarily in the figures. Data transmission time periods and distances encountered in actual circuits may differ from those shown in FIGS. 9-12.

OLT may prefer to request the ONUs to insert a delay before transmitting the range response message. For simplicity, such delays are not represented in the figures. However Frame Level 3R OEO Reach Extender is aware of such delays and preferably accounts for those in the automatic delay synchronization scheme.

### Normal Mode Operation

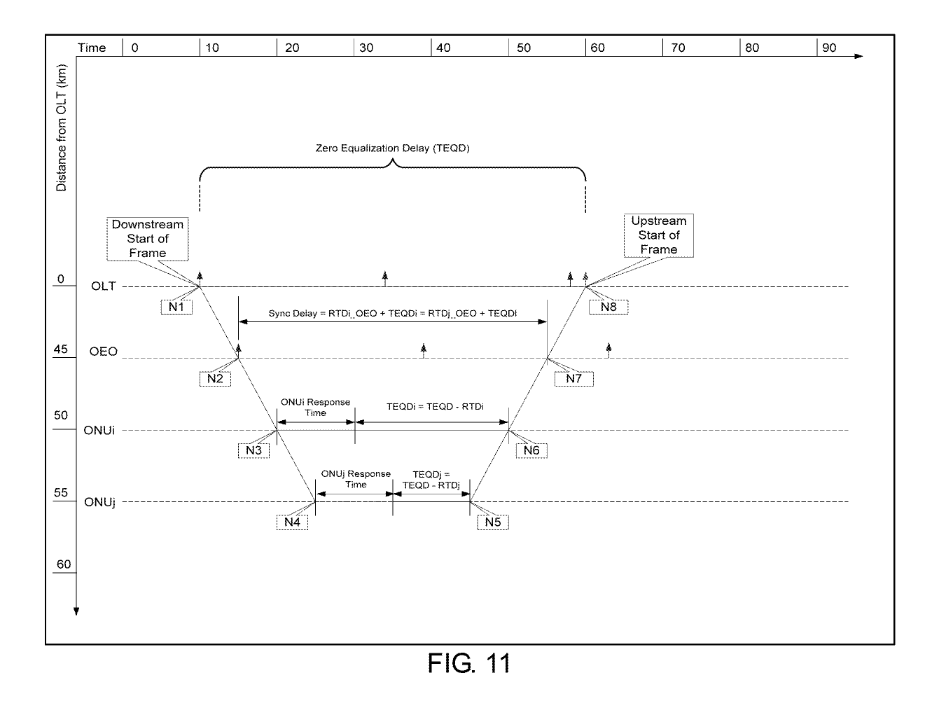

FIG. 11 shows the usage of the information, extracted by Frame Level 3R OEO Reach Extender, during normal mode of operation.

N1—Start of downstream frame in OLT.

N2—Start of downstream frame in Frame Level 3R OEO Reach Extender.

N3—Start of downstream frame in the ONUi

N4—Start of downstream frame in the ONUj

N5—Start of upstream frame in ONUj

N6—Start of upstream frame in ONUi

N7—Start of upstream frame in Frame Level 3R OEO Reach Extender

N8—Start of upstream frame in OLT.

With available information and precise measurements, the Frame Level 3R OEO Range Extender (OEO) can easily determine the logical distance of ONUs in the system from the OEO, and the expected burst arrival time from the ONUs.

Expected burst from ONUi=RTDi_{—}OEO+TEQDi

Expected burst from ONUj=RTDj_{—}OEO+TEQDj

Thus, the delays TEQDi and TEQDj are preferably configured such that the ONUs (ONUi and ONUj) appear to be located at the same distance from OLT. The same is true for Frame Level 3R OEO Reach Extender also. That is, the OEO reach extender can also be made to appear to be located the same distance away from the OLT as the respective ONUs.

(RTDi_{—}OEO+TEQDi)=(RTDj_{—}OEO+TEQDj)

Since these values are same, Frame Level 3R OEO Range Extender may choose any ONU in the system as a Reference ONU in the system, based on which the range extender can automatically configure its operating parameters. Also, this value is essentially the Equalization Delay of OEO plus its own response time.

Some embodiments of the present invention may include the following beneficial features and attributes.

1. In an embodiment, a Frame Level 3R regeneration of Downstream (DS) and Upstream (US) data streams may include:

a. Automatic (or Autonomous) Burst Control Data extraction logic to precisely determine the upstream burst boundaries

upstream delimiter pattern is searched only at the expected time.

Delimiter detection is blocked at other times to prevent false detection of a possible occurrence of the delimiter pattern in the burst payload.

b) Upstream burst detection logic is used determine the time intervals to reset optical receiver logic for better O/E conversion to achieve high Signal to Noise ratio. Most state of the art GPON systems use a resettable O/E receiver.

c) An embodiment includes a capability for determining the upstream received per ONU optical power (RSSI). This is an important feature in an OEO device because it terminates the burst level optical signal.

d) An embodiment may include the ability to absorb the propagation delay differences (the drift) from different ONTs and buffering logic to correct the received drift as needed.

e) An embodiment may include the ability to repair (or re-insert) the impaired preamble bits and delimiter bits.

f) In an embodiment, loss in the upstream bandwidth budget can be avoided because of the increased preamble requirement in a non Frame level regeneration OEO.

g) An embodiment may include the ability to dynamically determine the per-burst FEC enable/disable and appropriately apply it to correct the payload data.

2. A hardware based delay measurement logic to measure the logical distance of the OEO from the ONUs to determine the expected upstream burst boundaries based on the extracted burst control data comprising,

A concept of a reference ONU which can be internal or external to the OEO. The reference ONU can be any user ONU eliminating the need for a dedicated ONU for this purpose.

Ability to automatically and precisely measure the RTD between the OEO and the reference ONU for accommodating the environmental changes in the fiber characteristics eliminating the need for manual tuning.

Ability to automatically adapt to the OLT Equalization delay adjustments to the ONUs. This important to determine the expected upstream burst intervals based on the extracted burst control data.

Hardware based autonomous synchronization scheme reduces the time required to range the ONUs in a system, resulting in more wire-like transparent behavior. An OEO Reach Extender using this technique can be inserted in an existing operating GPON port without software intervention and with negligible increase in the range time.

3. Automatic learning of GPON protocol parameters (including preamble pattern and size and delimiter pattern) to achieve transparent and highly interoperable behavior:

Eliminates the need for manual setting of these parameters and/or software intervention.

Allows OEO to interoperate with GPON Systems using different parameter settings

Reduces the time required to range ONUs serviced through an OEO Reach Extender.

4. Control logic to improve Burst Mode CDR operation that may include:

Capability to dynamically tune the BCDR based on burst boundaries—only possible with Frame Level regeneration.

5. Ability to monitor traffic and relay port level and ONU-level statistics comprising of,

mechanism to determine ONU-id to allocation-id mapping

mechanism to determine ONU state information to determine appropriate stats.

ability check and report GPON standard compliant statistics like BIP, LOS, LOF, DOW, Unexpected Burst, FEC errors

6. An embodiment may include the ability to convert burst-mode transmission to continuous mode transmission by including

a mechanism to fill the gap between bursts to achieve continuous operation to make use of generic OTN transport options; and/or

a mechanism for conversion to continuous mode which enables the use of off the shelf Coarse WDM optics (not designed for burst mode operation) to multiplex multiple PON ports into a single fiber.

7. An embodiment may include the capability for in-band and out-of-band system management, which may include: an option for an internal ONT in fallback mode for in-band management and/or an ability for remote system upgrade with minimal downtime.

8. An embodiment may support “Electrical Split”: increasing the number of ONTs in a port beyond that is supported by the single port optical budget.

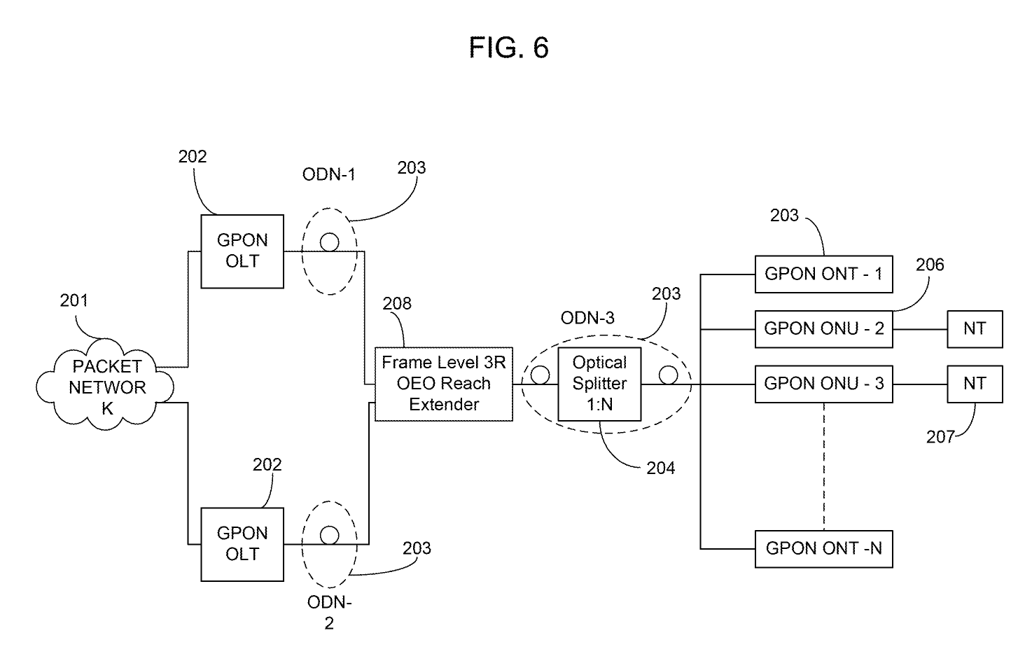

9. An embodiment may support PON protection: In this embodiment, the Downstream O/E module and the Upstream E/O module (which both reside on the OLT-facing side of the RE) support two optical interfaces through which the RE is connected to two different OLT ports, one working and one standby, via two geographically diverse fiber paths, as shown in FIG. 6. The two OLT ports aforementioned may belong to the same or different OLT systems. In this protected-PON scheme, the OLT systems (or the OLT system if the OLT ports belong to the same system) ensure that only one of the two OLT ports transmits (into one of the fiber paths) at any given time in the downstream direction. The transmissions from the ONUs in the upstream direction, however, are sent on both the fiber paths. With regards to realizing reach extension for such a protected PON, prior art implementations may use two sets of OEO RE modules, one each for connection to each OLT port. In this embodiment, an electrical multiplexer/demultiplexer is used to combine/split the signals from/to both the fiber paths before/after the signals are subject to the regeneration process. Thus in this embodiment, only one set of regeneration elements is required to realize reach extension for a protected PON.

a. PON path protection

b. An embodiment that is a variant of that in item 9 above wherein the two fiber paths may get terminated onto the same OLT port (e.g., the GPON-MAC port) via two optical layer interfaces. The electrical multiplexer/demultiplexer embodiment stated above applies to this scenario as well wherein the PON paths are protected.

10. An embodiment may include a Downstream Frame level regeneration that may include

a. an ability to absorb the drift introduced in the fiber from OLT to OEO which improves the CDR's jitter/wander performance on long fibers; an ability to monitor errors and report statistics; and/or an ability to determine autonomously the FEC status, and determine & correct errors as needed. The FEC correction can improve the optical link budget, thereby improving the distance between OLT and OEO (and ONTs).

b. An embodiment may include an ability to repair a downstream PSYNC pattern to improve the frame synchronization of the ONT.

11. An embodiment may include the ability to work without having an ONT embedded in the OEO range extender. i.e. this may involve the use of an external reference ONT mode. Benefits of this arrangement may include:

a. the distance of the OEO to the farthest ONT distance can be greater than 20 km when operating within an external-reference ONT mode.

b. Preferably, the External reference ONT can be any distance away from the OEO (within the protocol limit).

### Further Embodiments

In one embodiment, a method and apparatus for Frame Level 3R regeneration of Downstream and Upstream data streams in an OEO PON Reach Extender may include the following.

The embodiment may include automatic upstream burst control data extraction logic to precisely determine the upstream burst boundaries. Preferably, the upstream delimiter pattern is searched only at the expected time. The delimiter detection is preferably blocked at other times to avoid incorrectly detecting a delimiter pattern within the burst data payload.

The embodiment may include upstream burst detection logic to determine the time intervals needed to reset the upstream O/E convertor module to achieve high Signal to Noise ratio. GPON systems herein may use a resettable O/E convertor. Similar dynamic control is applied to the Burst mode CDR to achieve error-free burst mode clock recovery and phase lock.

The embodiment may include the ability to absorb the propagation delay differences (the drift) from different ONUs and buffering logic to correct for drift introduced by the O/E (optical to electrical) conversion. The drift control module can also compensate for the received drift due to the fiber length on a need basis.

The embodiment may include the ability to precisely restore impaired preamble pattern bits. The preamble pattern and size is autonomously determined to achieve transparent and highly interoperable behavior. The autonomous method of determining the preamble pattern and size reduces the time required to range ONUs serviced through an OEO Reach Extender. If an OEO Reach Extender does not restore the impaired or lost preamble bits, number of preamble bits needs to be increased thus increasing the burst level overhead.

The embodiment may include the ability to restore the impaired Delimiter pattern in the upstream direction. The delimiter pattern could be impaired by the O/E conversion or through the fiber length from ONUs to OEO. Correcting the Delimiter pattern before relaying to OLT helps to reduce the OLT's frame delineation errors. The delimiter pattern and size are autonomously determined like the preamble described above. The similar PSYNC restoration method is employed in the downstream direction.

The embodiment may include the ability to dynamically determine the per-burst FEC enable/disable and appropriately apply it to correct the payload data before relaying it to the OLT in upstream direction and ONUs in downstream direction. This way, additive errors can be avoided improving the overall packet data loss performance.

The embodiment may include a hardware-based delay measurement system to measure the logical distance of the OEO from the ONUs to determine the expected upstream burst intervals based on the extracted burst control data, wherein the system may include the following.

The embodiment may include a reference ONU which can be internal or external to the OEO range extension hardware. The reference ONU can be any user ONU, thereby eliminating the need for a dedicated ONU for this purpose.

The embodiment may include the ability to automatically and precisely measure the response time delay (RTD) between the OEO reach-extender device and the reference ONU for accommodating the environmental changes in the fiber characteristics, thereby eliminating the need for manual tuning

The embodiment may include the ability to automatically adapt to the OLT Equalization delay adjustments to the ONUs, thereby enabling determining the expected upstream burst intervals based on the extracted burst control data.

The embodiment may include Hardware-based autonomous synchronization scheme reduces the time required to range the ONUs in a system, resulting in more wire-like transparent behavior. An OEO Reach Extender using this technique can be inserted in an existing operating GPON port minimal traffic loss.

An embodiment may include a system for converting burst-mode data transmission to continuous mode transmission that may include the following.

The embodiment may include a mechanism to fill the gap between bursts to achieve continuous operation to make use of generic OTN transport options.

The embodiment may include an ability to conduct conversion to continuous mode data transmission to enable the use of Coarse WDM to multiplex multiple PON ports into a fiber.

An embodiment may include a method for increasing the number of ONUs that can be served with a PON port beyond its optical link budget, using a technique called Dynamic Electrical Split. The Dynamic Electrical Split is achieved through the precise determination of the upstream burst boundaries and selectively monitoring the two electrical streams based on the burst control data and merging the streams to form a single port for data transmission.

An embodiment may include a method to achieve PON path protection with OEO PON Reach Extenders. By intelligently controlling an input data path multiplier, path protection is achieved through the OEO PON Reach Extender.

An embodiment may include a system for in-band and out-of-band system management and an ability to monitor traffic and relay port level and ONU level statistics, wherein the system may include the following.

The embodiment may include a mechanism to determine ONU-ID to Allocation-ID mapping. Explicit information of ONU-ID may be omitted from the burst control data; instead Allocation-ids may be used to distinguish traffic from different ONUs.

The embodiment may include a mechanism to determine ONU state information to determine appropriate statistics.

The embodiment may include an ability to check and report GPON standard compliant statistics such as BIP, LOS, LOF, DOW, Unexpected Burst, and FEC errors.

The embodiment may include a method for an internal ONU in fallback mode for in-band management. The core OEO functions can be serviced or upgraded through the use of this fallback mode in-band management technique.

The embodiment may include the ability to determine the upstream received optical power for each ONU, which is a useful feature in an OEO because the burst level optical signal terminates at the OEO.

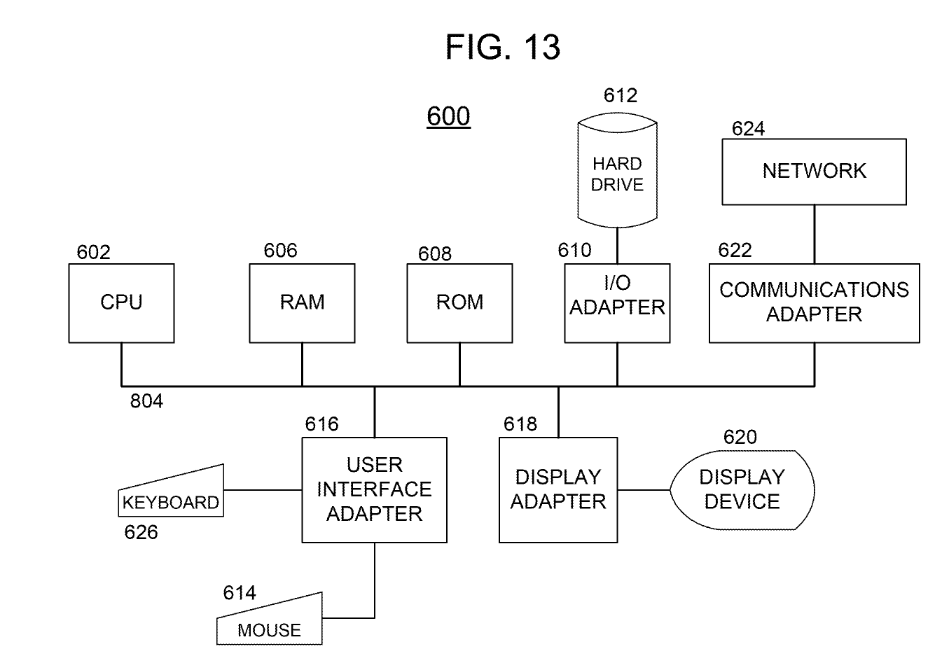

FIG. 13 is a block diagram of a computing system 600 adaptable for use with one or more embodiments of the present invention. Central processing unit (CPU) 602 may be coupled to bus 604. In addition, bus 604 may be coupled to random access memory (RAM) 606, read only memory (ROM) 608, input/output (I/O) adapter 610, communications adapter 622, user interface adapter 606, and display adapter 618.

In an embodiment, RAM 606 and/or ROM 608 may hold user data, system data, and/or programs. I/O adapter 610 may connect storage devices, such as hard drive 612, a CD-ROM (not shown), or other mass storage device to computing system 600. Communications adapter 622 may couple computing system 600 to a local, wide-area, or global network 624. User interface adapter 616 may couple user input devices, such as keyboard 626, scanner 628 and/or pointing device 614, to computing system 600. Moreover, display adapter 618 may be driven by CPU 602 to control the display on display device 620. CPU 602 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An optical network comprising:
an optical-electrical converter module within an OEO (Optical Electrical Optical) reach extension system (OEO RE system), the OEO RE system having an OEO port and including:
a downstream frame regeneration block; and
a downstream control data extraction block including a GPON operating parameter extraction module (GOPEM),
wherein the GOPEM is operable to extract at least one OEO-port operating parameter from data frames arriving at the GOPEM module.

2. The optical network of claim 1 wherein the at least one operating parameter includes a pattern and a size of an upstream preamble pattern.

3. The optical network of claim 1 wherein the at least one operating parameter a pattern and a size of an upstream delimiter pattern.

4. The optical network of claim 1 wherein the at least one operating parameter is an equalization delay to be used for synchronizing an upstream data transmission with a an upstream data transmission.

5. The optical network of claim 1 wherein the downstream frame regeneration block further comprises:
a physical synchronization repair module.

6. The optical network of claim 5 wherein the downstream frame regeneration block further comprises:
a forward error correction module.

7. An OEO module in an optical network, the OEO module comprising:
downstream frame regeneration block;
a data extraction block; and
an upstream frame regeneration block operable to achieve accurate frame delineation by searching delimiter patterns in data frames.

8. The OEO module of claim 7 further comprising:
an upstream burst control module for determining time intervals at which reset optical-electrical (OE) converters.

9. The OEO module of claim 7 wherein the upstream frame regeneration block comprises:
an upstream deframer module for determining upstream burst boundaries using extracted burst control data.

10. The OEO module of claim 7 wherein the upstream frame regeneration block comprising:
a restoration module for restoring preamble and delimiter bits impaired by optical-electrical data conversion.

11. The OEO module of claim 10 further comprising a parameter extraction module for determining a pattern and a size of the preamble and delimiter.

12. The OEO module of claim 7 wherein the upstream frame regeneration block comprises a burst to continuous mode conversion module for determining transmission data burst boundaries.

13. The OEO module of claim 7 wherein the upstream frame regeneration block comprises an forward error correction module.

14. The OEO module of claim 7 further comprising:
A timing distribution block in communication with both the downstream frame regeneration block and the upstream frame regeneration block.

15. The OEO module of claim 7 wherein the downstream control data extraction block comprises:
a GPON operating parameter extraction block.

16. The OEO module of claim 15 wherein the downstream control extraction block further comprises:
a burst control data extraction block.

17. The OEO module of claim 7 further comprising:
a burst mode clock and data recovery module in communication with the upstream frame regeneration block.
